(19) United States
(12) Patent Application Publication
(10) Pub. No.: US 2005/0068290 A1
(43) Pub. Date: Mar. 31, 2005

(54) Method for creating and using user-friendly grids

(76) Inventor: Denny Jaeger, Oakland, CA (US)

Correspondence Address: Wilson & Ham;PMB: 348, 2530 Berryessa Road, San Jose, CA, 95132, US

(21) Appl. No.: 10/674,005

(22) Filed: Sep. 28, 2003

(51) Int. Cl. G09G 5/00

(52) U.S. Cl. 345/156

(57) ABSTRACT

A graphic user interface and method for creating and using grids includes displaying one or more grids as graphic objects having many of the properties associated with common graphic objects. As a result, the grids may be independently moved and/or resized in a manner similar to the moving and/or resizing of other graphic objects. In addition, the grids may be snapped to other grids in a manner similar to then snapping of other graphic objects to a grid. Thus, an complex composite grid can be formed by snapping multiple grids together.

### FIELD OF THE INVENTION

The invention relates generally to computer programs, and more particularly to a method for creating and using a grid.

### BACKGROUND OF THE INVENTION

The ability to create and use a grid is a useful feature in computer programs, such as word processing programs, image processing programs, drawing programs and computer-assisted design (CAD) programs. A typical grid in a conventional computer program is formed of intersecting horizontal and vertical lines that appear on the entire drawing surface or a part of the drawing surface on which a user can type texts and/or draw objects. These grid lines are affixed to the drawing surface so that a user can move texts and/or objects relative to the grid lines.

The grid lines help the user to move and align text and/or objects on the drawing surface. Usually, a “snap to grid” option can be activated so that text and/or objects can automatically align to a grid line or a grid vertex (an intersection of vertical and horizontal grid lines). Thus, the “snap to grid” option can be used to accurately align texts and/or objects relative to each other.

In conventional computer programs with the grid feature, the vertical spacing between adjacent horizontal grid lines and/or the horizontal spacing between adjacent vertical grid lines and be defined by the user. These settings are applied to all of the horizontal grid lines and/or all of the vertical grid lines.

A concern with the grid feature of conventional computer programs is that, in order to change the spacing between adjacent horizontal or vertical grid lines, the horizontal or vertical spacing setting must be changed in a menu that automatically closes when the new setting is applied. Only after the new setting is applied does the grid change accordingly. Thus, if the new setting does not produce the desired grid appearance, the user must reopen the menu, enter a new spacing setting, and apply that setting, which again automatically closes the menu. This process may have to be repeated several times to produce the desired grid.

Another concern with the grid feature of conventional computer programs is that, since the grid lines are uniformly spaced throughout the entire grid in the horizontal and/or vertical directions, the user must change the horizontal and/or vertical spacing settings, as described above, to align different groups of texts and/or objects using horizontal and/or vertical gridlines having different spacings. Thus, as the desired layout of the texts and/or objects becomes more complex, the number of time the horizontal and/or vertical spacing settings have to be changed increases.

With respect to the “snap to grid” option of the grid feature of conventional computer programs, a concern is that a corner or a side of a text or object that a user is trying to snap to the grid will sometimes not snap to the desired grid line or vertex. This may be due to the fact that in some conventional computer programs only a particular corner or side of a text or object can snap to a grid line or vertex. Such limitation may frustrate a user who is simply trying to align a text or object to a desired location.

Another concern with respect to the “snap to grid” option is that, when this option is active, a text or object being moved over the grid by the user jumps from one position to another in predefined distances. Thus, the user cannot move the text or object in a continuously smooth fashion, which presents an unusual or unnatural movement for a dragged text or object.

In view of these concerns, what is needed is a graphic user interface and method for creating and using grids that addresses the described concerns.

### SUMMARY OF THE INVENTION

A graphic user interface and method for creating and using grids includes displaying one or more grids as graphic objects having many of the properties associated with common graphic objects. As a result, the grids may be independently moved and/or resized in a manner similar to the moving and/or resizing of other graphic objects. In addition, the grids may be snapped to other grids in a manner similar to then snapping of other graphic objects to a grid. Thus, a complex composite grid can be formed by snapping multiple grids together.

A method for creating and using grids in accordance with an embodiment of the invention includes activating a grid feature to create one or more grids, and displaying a grid as a graphic object at a location on a display surface in response to user input. The grid includes parallel lines along a first direction and at least one line along a second direction to intersect one of the parallel lines. The size and location of the grid are defined by the user input.

Other aspects and advantages of the present invention will become apparent from the following detailed description, taken in conjunction with the accompanying drawings, illustrated by way of example of the principles of the invention.

### BRIEF DESCRIPTION OF THE DRAWINGS

FIG. 1 shows an overall grid of a Blackspace canvas in accordance with an embodiment of the invention. The term “Blackspace” is a trademark of NBOR Corporation.

FIG. 2 shows an Info Canvas object for the Blackspace canvas that is used to view the overall grid of the Blackspace canvas. The term “Info Canvas” is a trademark of NBOR Corporation.

FIG. 3 shows a graphic rectangular object with possible align points and hotspots.

FIG. 4 shows a graphic triangular object with possible align points and hotspots.

FIG. 5 shows a graphic star object with possible align points and hotspots.

FIG. 6 shows a graphic circular object with possible align points and hotspots.

FIGS. 7A and 7B illustrate moving a graphic star object to snap the object to a grid using an align point of the object.

FIGS. 8A and 8B illustrate moving a graphic star object to snap the object to a grid using another align point of the object.

FIGS. 9A, 9B, 9C and 9D illustrate moving a graphic object to snap the object to a grid using an align point of the object.

FIGS. 10A, 10B, 10C and 10D illustrate moving a graphic object to snap the object to a grid using another align point of the object.

FIG. 11 shows an overall grid of a VDACC object. The term “VDACC” is a trademark of NBOR Corporation.

FIG. 12 show an Info Canvas object for the VDACC object of FIG. 11, which can be used to change the properties of the overall grid of the VDACC object.

FIGS. 13A and 13B illustrate changing the size of the overall grid of the VDACC object on the screen by enlarging or reducing the viewable area of the VDACC object.

FIG. 14 shows a free grid on the Blackspace canvas and a free grid on a VDACC object.

FIG. 15 illustrates the method for creating a free grid in accordance with an embodiment of the invention.

FIG. 16 show the Info Canvas object for a free grid.

FIGS. 17A and 17B illustrate how a free grid snaps back to the original size if the grid is not increased by at least one grid square in either horizontal or vertical direction.

FIGS. 18A and 18B illustrate how a free grid can be resized.

FIG. 19 shows two overlapping free grids.

FIGS. 20A and 20B illustrate how a graphic object is snapped to overlapping free grids.

FIGS. 21A and 21B also illustrate how a graphic object is snapped to overlapping free grids.

FIGS. 22A and 22B illustrate three different free grids that are snapped together.

FIG. 23 depicts a flowchart that shows the logical steps for a method of creating a new grid (“NEWGRID”) in accordance with an embodiment of the invention.

FIG. 24 shows a VRT switch and the Info Canvas for that switch, which can be used to create free grids.

FIG. 25 depicts a flowchart that shows the snap-to-grid point calculation when object drag is begun.

FIG. 26 depicts a flowchart that illustrates an Object's interaction with Grids while being dragged.

FIG. 27 depicts a flowchart that illustrates an Object's interaction with Grids when dropped (placed) onto a grid after being dragged to overlap some portion of that grid.

FIG. 28 shows the logical steps for the method of moving a Grid and changing it's appearance while doing so to provide enhanced screen clarity and user feedback.

FIG. 29 shows the logical steps for the method of dropping a Grid and changing it's appearance once dropped to provide enhanced screen clarity and user feedback.

FIG. 30 is a diagram of a computer system in which the invention has been implemented.

FIG. 31 is a flow diagram of a method for creating and using grids in accordance with an embodiment of the invention.

### DETAILED DESCRIPTION

The present invention includes a user-friendly graphic user interface and method for creating and using grids in an operating environment of a computer system or any computing system with a display. The invention is described with respect to a computer operating environment referred herein to as “Blackspace” environment. The word “Blackspace” is a trademark of the NBOR Corporation. Blackspace environment presents one universal drawing surface that is shared by all graphic objects within the environment. Blackspace environment is analogous to a giant drawing “canvas” on which all graphic objects generated in the environment exist and can be applied. Each of these graphic objects can have a user-created relationship to any or all the other objects. There are no barriers between any of the objects that are created for or exist on this canvas. However, the invention is not limited to the Blackspace environment and can be implemented in any computer operating environment.

As used herein, the term “objects” include recognized graphic objects (e.g., stars, squares, circles, arrows, etc.), free drawn objects (sketches, drawings, lines, etc.), pictures in various file format (.png, .jpg, .bmp, .gif, etc.), graphic control devices (switches, faders, knobs, joysticks, etc.), videos in various file format (.mpg, .avi, .mov, etc.), text, and other graphic objects or portions of graphic objects that are displayed on a display device.

In accordance with an embodiment, the invention provides two different types of grids, overall grids and free grids. An overall grid is a grid of intersecting parallel horizontal and vertical grid lines that can be made to appear on the entire Blackspace canvas or a canvas of a [Virtual or Visual] Display and Control Canvas (VDACC) object. The term “VDACC” is a trademark of NBOR Corporation. A VDACC object includes a workspace surface or canvas that may be larger than the visible or viewable area of the VDACC object. Thus, a VDACC object allows a user to scroll the visible area to view graphic objects or contents in the VDACC object that were hidden from the visible area. However, the objects that appear to be in the VDACC object exist on the global Blackspace canvas. For more information about VDACC objects, see pending U.S. patent application Ser. No. xx/xxx,xxx, entitled “Intuitive Graphic User Interface with Universal tools”, filed on Sep. 26, 2003, which is incorporated herein by reference.

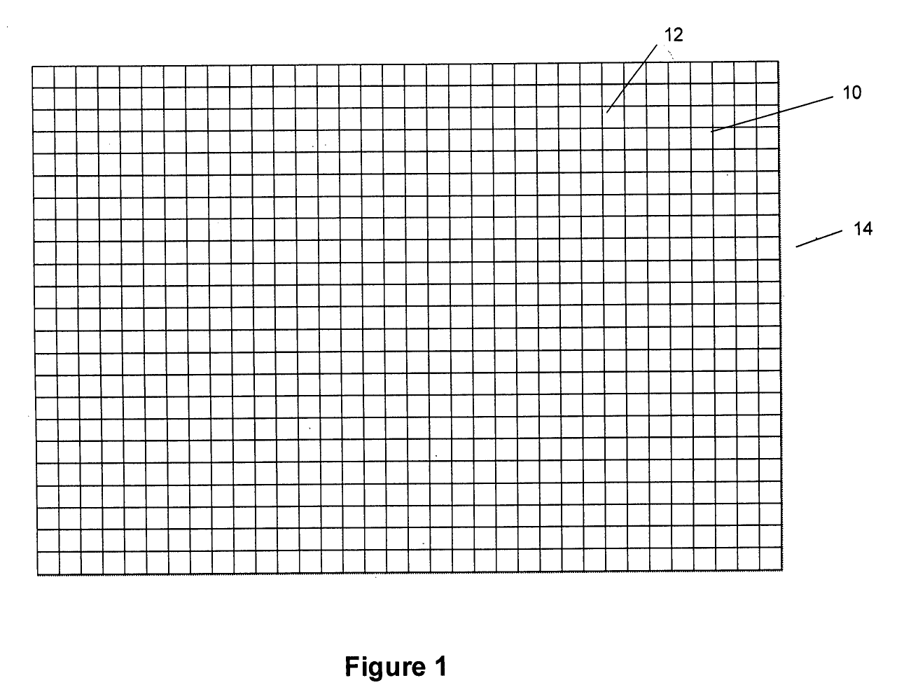

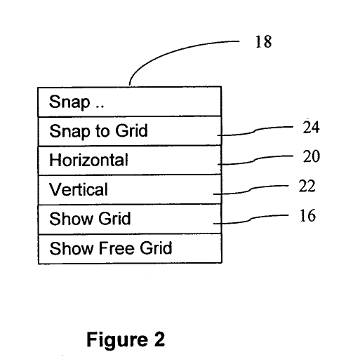

In FIG. 1, an overall grid 10 for the Blackspace canvas 12 is shown. This overall grid 10 can be made to appear on the screen 14 by selecting an appropriate entry in a menu or its equivalent. As an example, a “show grid” entry 16 of an Info Canvas object 18 for the Blackspace canvas 12, which is shown in FIG. 2, can be activated to make the overall grid 10 for the Blackspace canvas 12 to appear on the screen 14. The text “show grid” may change color to indicate whether the entry 16 is active (e.g., green) or inactive (e.g., gray). This color change approach may be used for other entries in this or other Info Canvas objects to indicate active and inactive states. The term “Info Canvas” is a trademark of NBOR Corporation. An Info Canvas object for the Blackspace canvas or any graphic object in the Blackspace environment provides entries to change the properties of the Blackspace environment or the associated graphic object or control functions related to the Blackspace environment or the associated object. Thus, an Info Canvas object serves as a menu for the Blackspace environment or an associated graphic object. For more information about Info Canvas objects, see pending U.S. patent application Ser. No. xx/xxx,xxx, entitled “Intuitive Graphic User Interface with Universal tools”, filed on Sep. 26, 2003. In any instance described herein when an entry of an Info Canvas object is used, an entry of a conventional menu or its equivalent can instead be used.

The horizontal spacing of the vertical grid lines of the overall grid 10 can be modified by the user by changing the numeric value in the “Horizontal” entry 20 of the Info Canvas object. The numeric value can represent any unit of distance, such as pixels, inches and millimeter. In contrast to the grid feature of conventional computer programs, when the numeric value in the “Horizontal” entry 20 is changed, the overall grid 10 is changed accordingly without having to close the Info Canvas object 18 containing that entry. Thus, a user can see the effect of the horizontal spacing change on the overall grid 10 to determine whether the spacing needs to be further modified. The vertical spacing of the horizontal grid lines of the overall grid 10 can be changed in a similar manner using the “vertical” entry 22 of the Info Canvas object 18.

The “snap to grid” option of the overall grid 10 can be made active by activating the “snap to grid” entry 24 of the Info Canvas object 18. When this option is active, a graphic object can be snapped to a horizontal or vertical grid line or a grid vertex of the overall grid 10. Similar to the text in an entry of an Info Canvas object, the color of the overall grid 10 may change to indicate an active “snap to grid” option (e.g., green) or an inactive “snap to grid” option (e.g., gray). In contrast to the grid feature of conventional computer programs, when a graphic object is dragged over the overall grid 10 (or any other grid in accordance with the invention) with an active “snap to grid” option, the object moves smoothly across the grid without any “jumps”, which presents a natural movement for the object being dragged.

The “snap to grid” option of the overall grid 10 has three settings. A first setting is that only the horizontal grid lines of the overall grid 10 are active for the “snap to grid” option. This setting can be achieved by activating the “horizontal” entry 20 and deactivating the “vertical” entry 22 in the Info Canvas object 18. In this case, graphic objects are snapped to only the horizontal grid lines of the overall grid 10 when the objects are released on the grid. Thus, graphic objects dragged onto the overall grid 10 can be placed anywhere along the horizontal direction in one pixel increments. However, the graphic objects will vertically snap to the nearest horizontal line, as defined from a selected align point on each object (described below). In this case, only the color of the horizontal grid lines of the overall grid 10 may be changed to indicate that these grid lines are active for the “snap to grid” option.

A second setting is that only the vertical grid lines of the overall grid 10 are active for the “snap to grid” option. This setting can be achieved by deactivating the “horizontal” entry 20 and activating the “vertical” entry 22 in the Info Canvas object 18. In this case, graphic objects are snapped to only the vertical grid lines of the overall grid 10 when the objects are released on the grid. Thus, graphic objects dragged onto the overall grid 10 can be placed anywhere along the vertical direction in one pixel increments. However, the graphic objects will horizontally snap to the nearest vertical line, as defined from a selected align point on each object. In this case, only the color of the vertical grid lines of the overall grid 10 may be changed to indicate that these grid lines are active for the “snap to grid” option.

A third setting is that both the horizontal and vertical grid lines of the overall grid 10 are active for the “snap to grid” option. This setting can be achieved by activating both the “horizontal” and “vertical” entries 24 and 22, respectively. In this case, graphic objects are snapped to the nearest vertex of the overall grid 10, as defined from a selected align point on each object. This setting may be a default for the “snap to grid” option. In this case, the color of both the horizontal and vertical grid lines of the overall grid 10 may be changed to indicate that these grid lines are active for the “snap to grid” option.

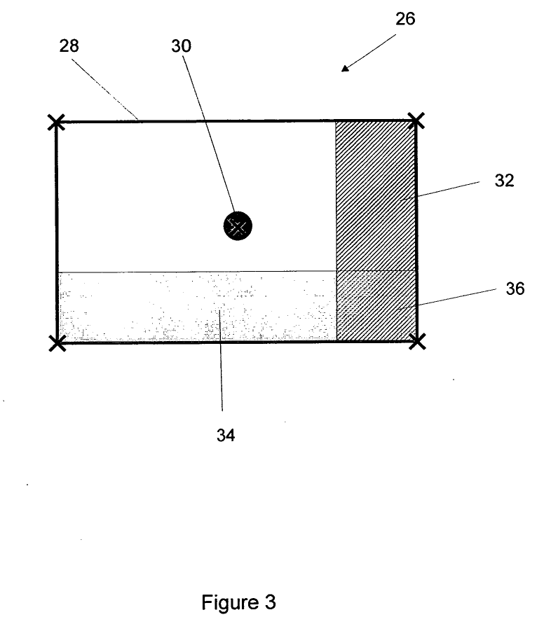

In an embodiment, graphic objects in the Blackspace environment include align points that are used when the objects are snapped to a grid, such as the overall grid 10. The align points may vary from one object to the next. As an example, in FIG. 3, a graphic rectangular object 26 is shown. As used herein, the terms “rectangle” and “rectangular” refers to any four sided object, including a square. The possible align points (indicated by “X” in FIG. 3) for this rectangular object 26 are the four corners of the bounding rectangle 28 for this object, as is the case for all graphic objects. The rectangular object 26 further includes an align point at the center of the object. In general, the center align point may or may not be at the center of the bounding rectangle 28 for a graphic object. This center align point is in a special/custom hotspot (region) 30. When a user mouse clicks in a special/custom hotspot to drags a graphic object to a grid with active “snap to grid” option, the align point associated with that special/custom hotspot is used to snap the object to a grid line or a grid vertex, depending on the setting of the active “snap to grid” option. Different graphic objects may include multiple special/custom hotspots.

The rectangular object 26 also includes a standard right-edge hotspot 32 and a standard bottom-edge hotspot 34. These hotspots 32 and 34 are used to determine which of the four corner align points to use for snapping the object 26 to a grid. If the user mouse clicks in the intersecting region 36 of the standard right-edge hotspot 32 and the standard bottom-edge hotspot 34 and then drags the object to a grid, then the lower right corner align point is used for snapping to the grid. If the user mouse clicks only in the standard right-edge hotspot 32 (excluding the intersecting region 36 of the standard right-edge hotspot and the standard bottom-edge hotspot 34) and then drags the object to a grid, then the upper right corner align point is used for snapping to the grid. If the user mouse clicks only in the standard bottom-edge hotspot 34 (excluding the intersecting region 36) and then drags the object to a grid, then the lower left corner align point is used for snapping to the grid. If the user mouse clicks in a location in the object not in one of the hotspots and then drags the object, then the upper left corner align point is used for snapping to the grid.

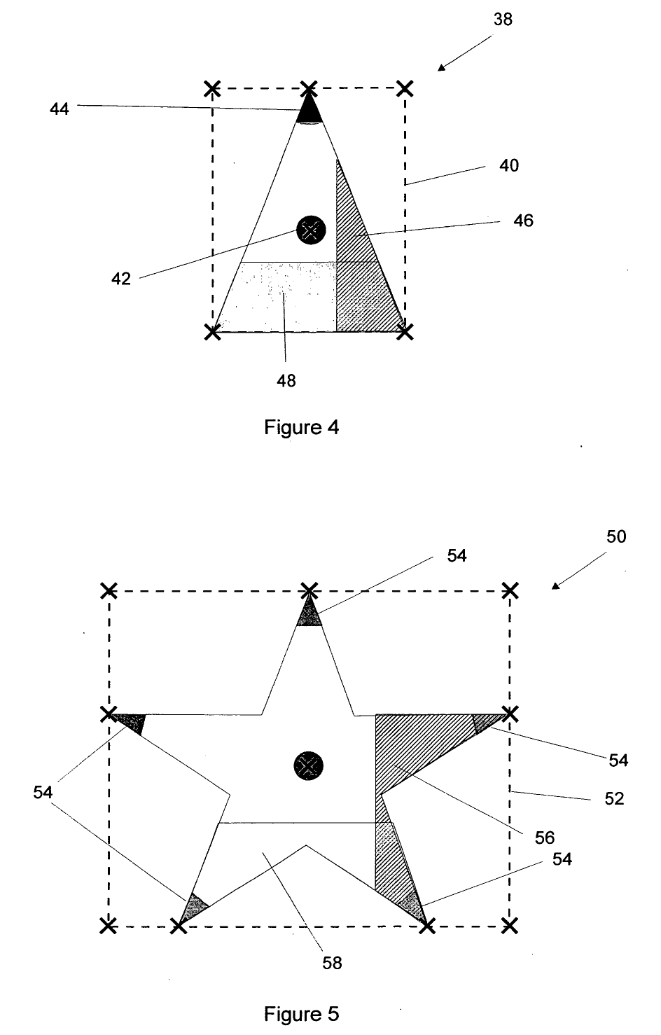

In FIG. 4, a graphic triangular object 38 with possible align points and hotspots are shown. The triangular object 38 includes the possible align points on the four corners of the bounding rectangle 40 for this object. The triangular object 38 also includes the possible center align point and a possible align point at the top tip of the object. These center and tip align points are associated with special/custom hotspots 42 and 44, respectively. Similar to the graphic rectangular object 26, the triangular object 38 includes a standard right-edge hotspot 46 and a standard bottom-edge hotspot 48. The selection of an align point for snapping the triangular object 38 to a grid is made in a similar manner as described above with reference to the graphic rectangular object 26.

In FIG. 5, a graphic star object 50 with possible align points and hotspots are shown. The star object 50 includes the possible align points on the four corners of the bounding rectangle 52 for this object. The stare object 50 also includes the possible center align point and five possible align point at the five tips of the object. These center and tip align points are associated with special/custom hotspots 54. The star object 50 includes a standard right-edge hotspot 56 and a standard bottom-edge hotspot 58. The selection of an align point for snapping the star object to a grid is made in a similar manner as described above with reference to the graphic rectangular object 26.

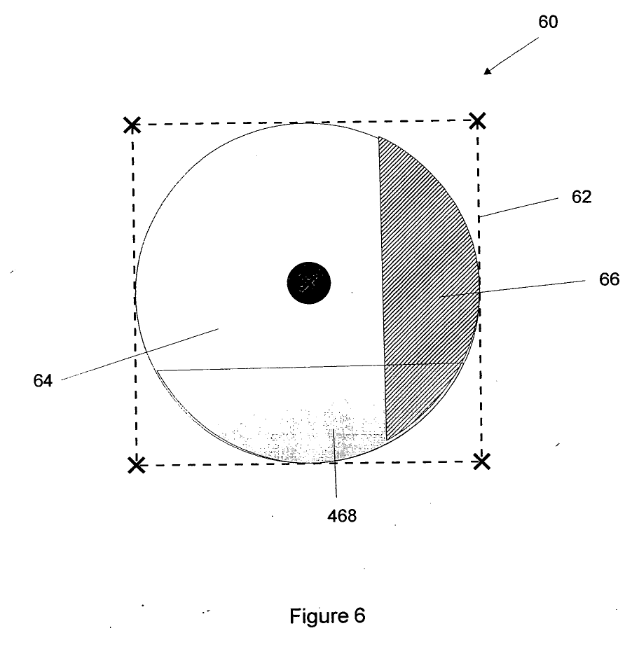

In FIG. 6, a graphic circular object 60 with possible align points and hotspots are shown. The circular object 60 includes the possible align points on the four corners of the bounding rectangle 62 for this object. The circular object 60 also includes the possible center align point, which is associated with a special/custom hotspot 64. The circular object 60 further includes a standard right-edge hotspot 66 and a standard bottom-edge hotspot 68. The selection of an align point for snapping the circular object to a grid is made in a similar manner as described above with reference to the graphic rectangular object 26.

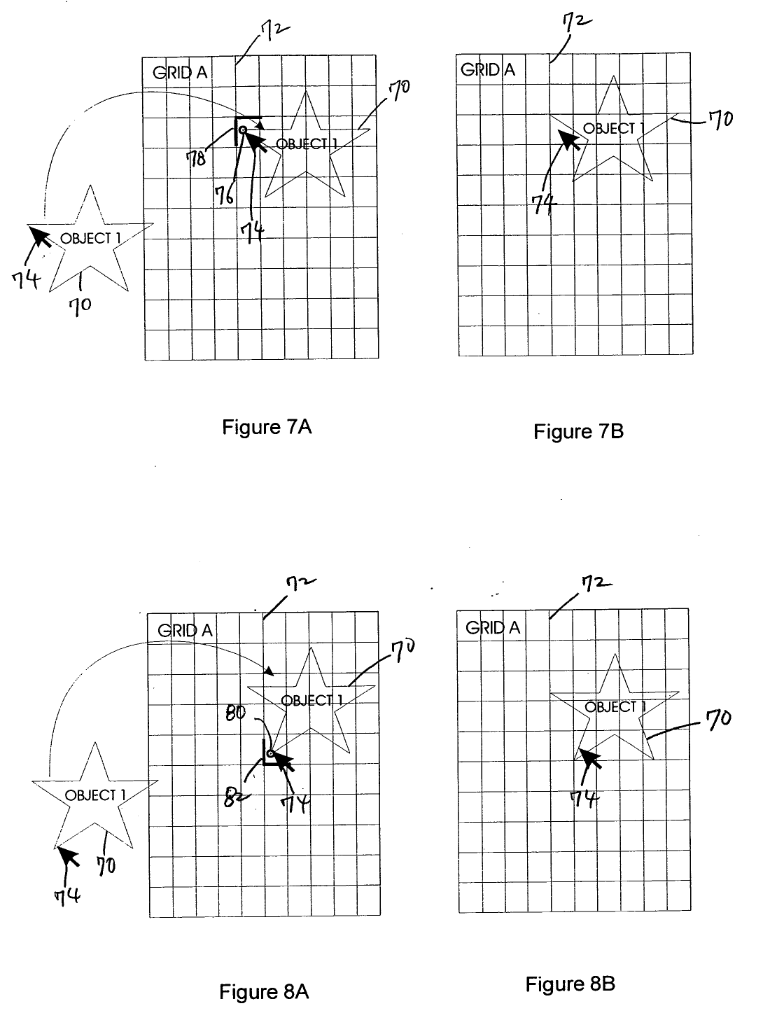

In order to provide a visual indication (“graphical hint item”) of the align point that will be used to snap a graphic object to a grid, when the object is dragged over the grid and the “snap to grid” option is active, a small circle that surrounds the selected align point of the object may be displayed. As illustrated in FIG. 7A, if a user mouse clicks in a hotspot of a star object 70 associated with a possible align point at the tip of the upper left tip of the star object and the star object is dragged over a grid 72 with active “snap to grid” option using the cursor 74, then a small circle 76 will appear around that align point. In other embodiments, any other graphic indicator can be used instead of a small circle, such as an “x”, one or more flashing lines and a pulsating graphic item near the selected align point on the object.

In addition, a visual indication on the grid 72 of the location on which the align point of the star object 70 would snap/move to (referred to herein as “snap position” of a grid) if the object is released at the current location may be displayed. As shown in FIG. 7A, the visual indication may be a thickened portion 78 (orthogonal corner) of the grid 72 to provide a snap position hint at the grid vertex that would be used to snap the selected align point of the star object 70 onto the grid 72 (assuming the “snap to grid” option is set to the third setting in which both the horizontal and vertical grid lines of the grid 72 are active). If the “snap to grid” option is set to the first setting in which only the horizontal grid lines are active, then the snap position hint 78 may be a thickened horizontal line segment between adjacent vertical grid lines. If the “snap to grid” option is set to the second setting in which only the vertical grid lines are active, then the snap position hint 78 may be a thickened vertical line segment between adjacent horizontal grid lines. In other embodiments, any other graphic indicator can be used to show the snap to location on the grid 72. FIG. 7B illustrates the start object 70 after the star object has been released from the location shown in FIG. 7A and snapped to the grid 72. As a result, the upper left tip of the star object 70 snapped to the grid vertex which was nearest to the selected align point of the star object.

FIG. 8A illustrates what would happen if the star object 70 is moved to and released at the same location as shown in FIG. 7A when the star object is initially clicked in a hotspot associated with the lower left tip of the star object. As shown in FIG. 8A, a small circle 80 that surrounds the selected align point at the lower left tip of the star object 70 is displayed and a portion 82 of the grid 72 is thickened to indicate a vertex (“snap position”) of the grid that the align point of the star object would be snapped to if the object is released from the current location. FIG. 8B illustrates the start object 70 after the star object has been released from the location shown in FIG. 8A and snapped to the grid 72. As a result, the lower left tip of the star object 70 snapped to the grid vertex which was nearest to the selected align point of the star object.

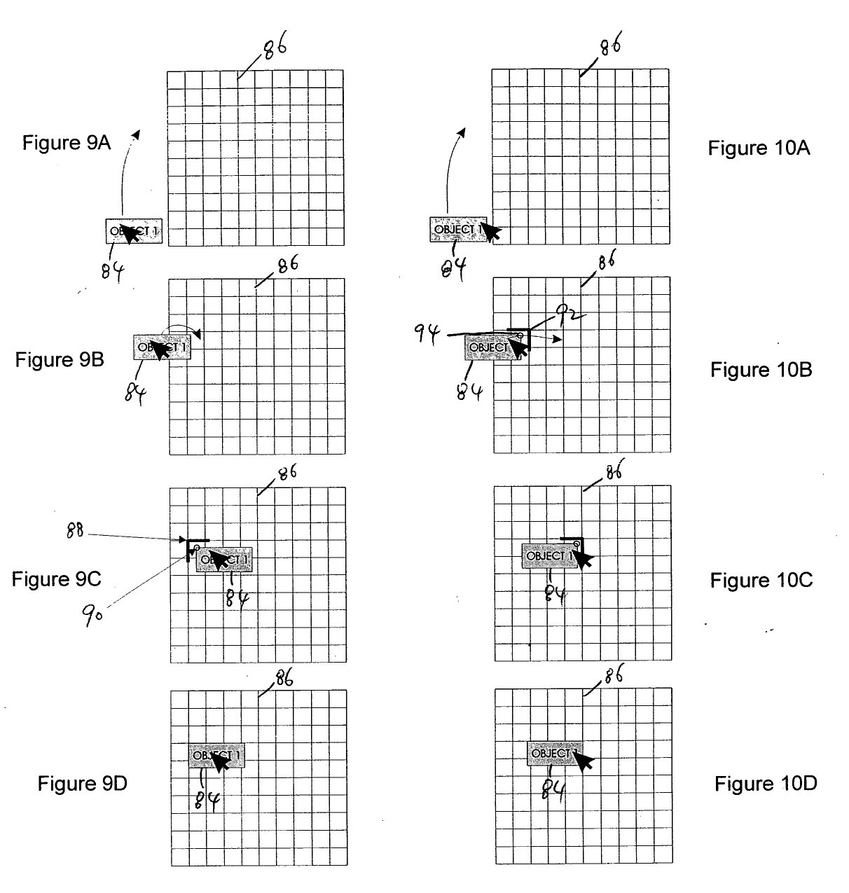

FIGS. 9A-9D further illustrate what happens when a graphic object 84 is picked up, moved (dragged) over a grid 86, and then dropped over the grid. In FIG. 9A, the user clicks and holds the object 84 with the mouse (i.e., the left mouse button pressed down when the cursor is over the object), and moves the object toward the grid 86. In response to the click point, the upper left corner align point of the object 84 is selected. In FIG. 9B, the user continues to move the object 84, and the object now partially overlaps the grid 86. However, the selected align point of the object 84 is not over the grid 86. Thus, no hint (e.g., a small circle) appears about the selected align point. In FIG. 9C, the user may have stopped moving the object 84 (although this is not necessary) and has just released the object 84. Thus, FIG. 9C shows the screen display at the instant before the object 84 is snapped to the grid 86. In FIG. 9C, the snap position hint 88 on the grid 86 and the align point hit 90 on the object 84 are displayed. In FIG. 9D, the object 84 is snapped to the grid 86 such that the selected align point of the object is snapped to the snap point of the grid.

Similar to FIGS. 9A-D, FIGS. 10A-D also illustrate what happens when the graphic object 84 is picked up, moved (dragged) over the grid 86, and then dropped over the grid. However, in this case, the object 84 is clicked such that the upper right corner align point of the object is selected, as shown in FIG. 10A. In FIG. 10B, the user continues to move the object 84, and the object now partially overlaps the grid 86. In contrast to FIG. 9B, the selected align point of the object 84 is over the grid 86 in FIG. 10B. Thus, the snap position and align point hints 92 and 94, respectively, are displayed. As the user continues to move the object 84 over the grid 86, the location of the snap position hint changes accordingly, as shown in FIG. 10C. In FIG. 10D, the object 84 is snapped to the grid 86 such that the selected align point of the object is snapped to the snap point of the grid.

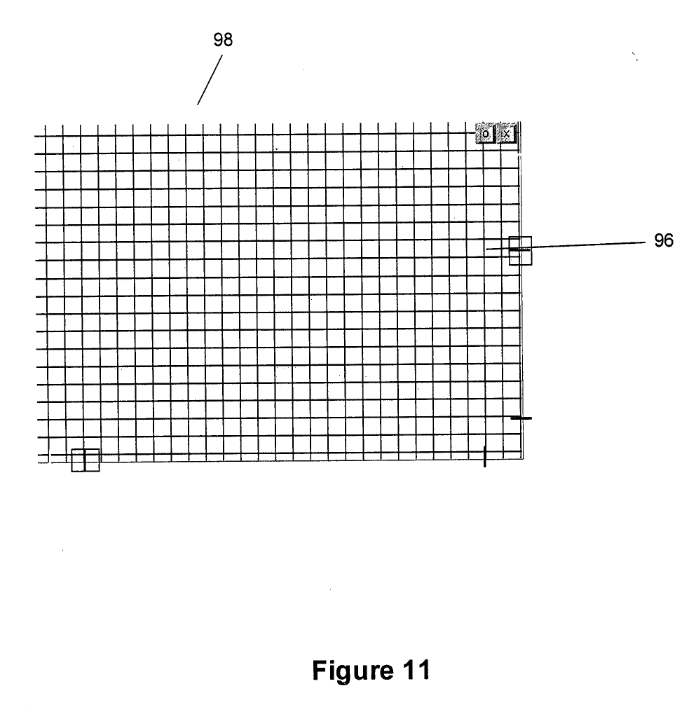

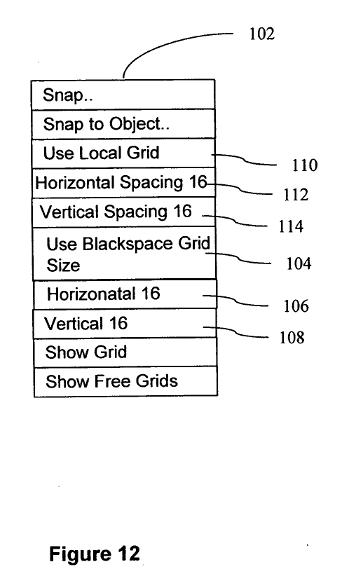

Turning now the FIG. 11, an overall grid 96 of a VDACC object 98 is shown. This overall grid 96 can be made to appear on the screen in the VDACC object 98 by activating “show grid” entry 100 of an Info Canvas object 102 for the VDACC object 98, as shown in FIG. 12. For a VDACC object, there are two sets of horizontal and vertical spacing settings. The first set includes the same horizontal and vertical spacing settings used for the overall grid of the Blackspace canvas. To use this set of spacing settings, the “use Blackspace grid size” entry 104 of the Info Canvas 102 is selected. The spacing settings in this set can be modified by changing the numeric values in the “horizontal” and “vertical” entries 106 and 108, respectively. The second set of spacing settings includes horizontal and vertical settings used for only the VDACC object. To use this set of spacing settings, the “use local grid” entry 110 of the Info Canvas object 102 is selected. The spacing settings in this set can be modified by changing the numeric values in the “horizontal local” and “vertical local” entries 112 and 114, respectively. Depending on the grid size being used, one of the entries 104 and 110 can be activated to turn on the “snap to grid” option for the overall grid 96. Again, the user can selectively activate the “snap to grid” option for horizontal grid lines and/or vertical grid lines by activating one or more appropriate entries 106, 108, 112 and/or 114. The “snap to grid” option for an overall grid of a VDACC objects operates in a similar manner as the “snap to grid” option for the overall grid of the Blackspace canvas.

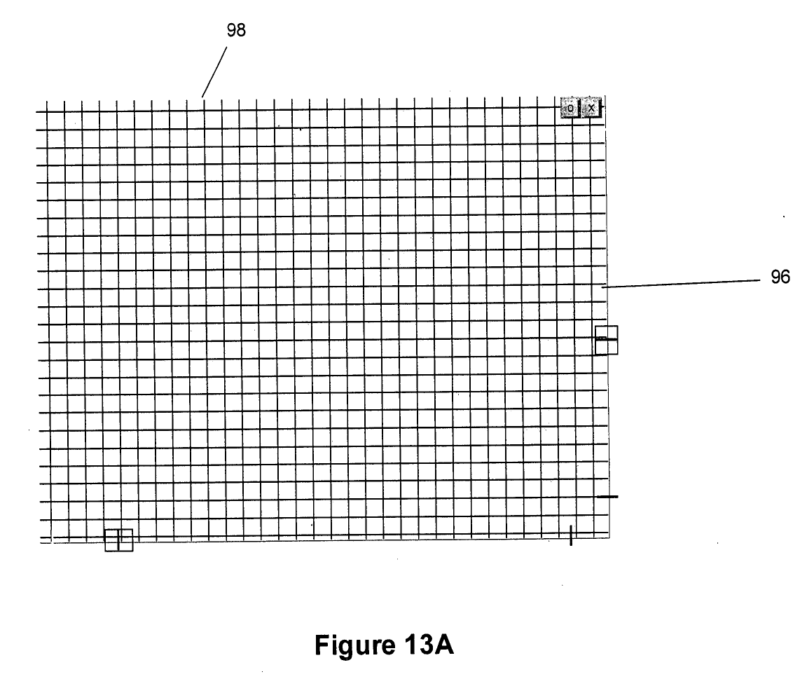

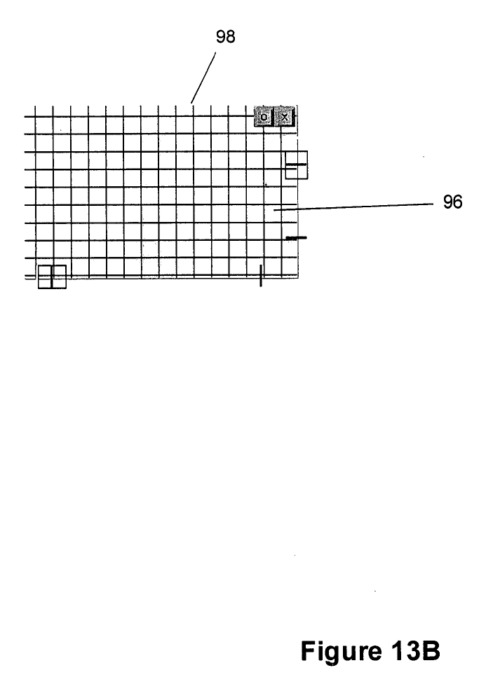

As illustrated in FIGS. 13A and 13B, the overall grid 96 of the VDACC object 98 can be changed in size on the screen by enlarging or reducing the viewable area of the VDACC object. As an example, the VDACC object 98 can be increased by moving the cursor over the bottom right corner of the VDACC object 98, which changes the cursor to a double arrow cursor, and then dragging the double arrow cursor away from the upper left corner of the VDACC object while pressing on the left mouse button, as illustrated in FIG. 13A. As a result, more of the overall grid 96 of the VDACC object 98 appears on the screen. In a similar manner, as shown in FIG. 13B, the VDACC object 98 can be reduced in size by dragging the double arrow cursor toward the upper left corner of the VDACC object.

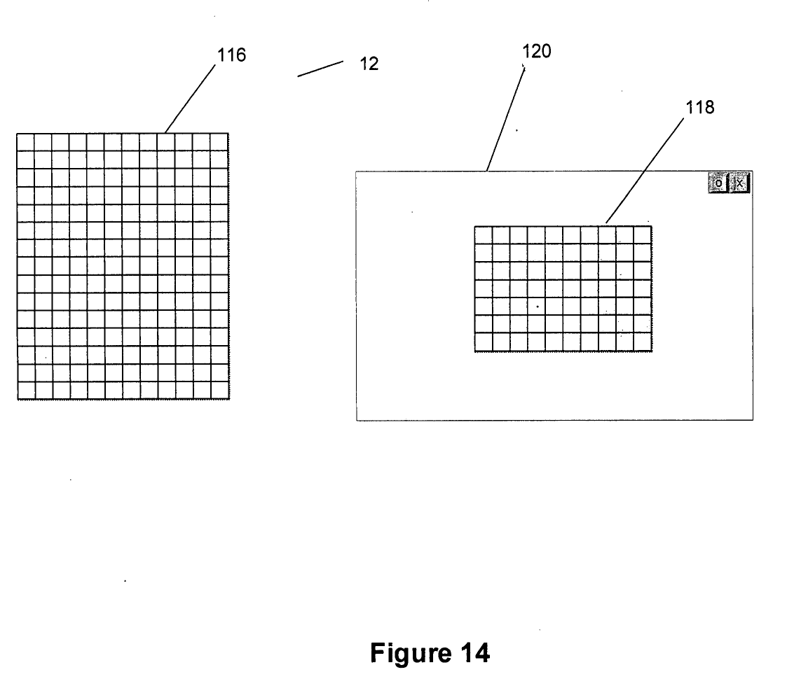

The other type of grids, i.e., free grids, provided by the invention is now described. Free grids are graphic objects that can be created on the Blackspace canvas or on a VDACC object. In FIG. 14, a free grid 116 on the Blackspace canvas 12 and a free grid 118 on a VDACC object 120 are shown. Free grids offer the following features:
A. User can create as many independent free grids as desired in one environment.
B. Point-of-origin of a free grid can be moved by the user at any time without having to enter coordinate information.
C. Free grids can be resized at any time without having to enter dimensional (length and width) information.
D. One or more free grids can overlap each other.
E. Free grids can be snapped to other free grids or overall grids.
F. Where a free grid overlaps another free grid or an overall grid, graphic objects can be snapped to partial grid squares.
G. Free Grids change their colors when the “snap to grid” option is activated or deactivated.
H. Free Grids automatically change their background colors to the background colors of VDACC objects when placed in the VDACC objects.
   A. User Can Create as Many Independent Free Grids as Desired in One Environment.

“Independent” means that each of the free grids can have its own unique properties, such as grid square sizes (horizontal and vertical spacing settings), the overall size of the free grid and the location of the free grid, which are all user-definable. “One environment” means a single VDACC object or the primary Blackspace environment (the Blackspace environment excluding environments in VDACC objects). There can be as many free grids in the primary Blackspace environment. Furthermore, there can be as many free grids in a VDACC object. Moreover, there can be as many VDACC objects (each with multiple free grids) in the Blackspace environment.

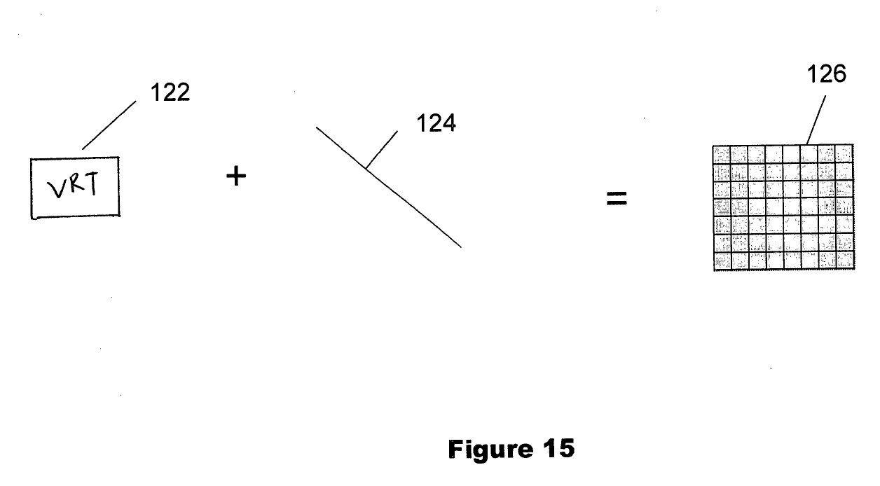

In the exemplary embodiment, a free grid is drawn by using a Virtual Recall Tool (VRT). For information on VRT (formerly named “Digital Recall Tool”), see pending U.S. patent application Ser. No. 10/053,075, entitled “Method for Controlling Electronic devices Using Digital Recall Tool, filed on Jan. 18, 2002, which is incorporated herein by reference. In order to draw free grids using the VRT, a VRT switch is set to draw free grids. This can be achieved by selecting the “draw grid” entry in the Info Canvas object for the VRT switch. As illustrated in FIG. 15, drawing a free grid using the VRT involves activating the VRT switch 122, and then drawing a diagonal line 124 using a cursor with the left mouse button pressed. When the left mouse button is released, a free grid 126 is displayed (created). The size of the free grid 126 is determined by the length and angle of the diagonal line 124. The height defined by the diagonal line 124 determines the height of the free grid 126, while the width defined by the diagonal line determines the width of the free grid. Thus, the size of a newly created free grid is easily controlled by the user. Furthermore, the position of a newly created free grid is easily controlled by the user since this position is also determined by the diagonal line drawn.

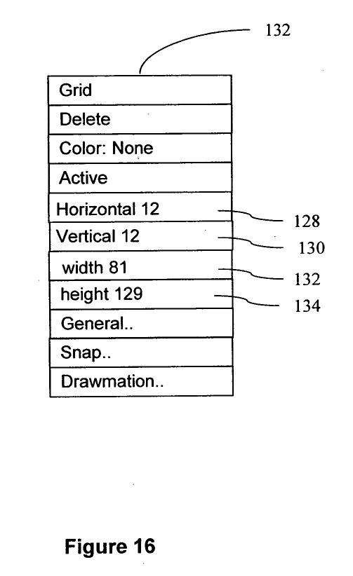

As illustrated in FIG. 16, the horizontal and vertical spacing settings for a free grid can be modified by entering the desired numeric values in the “horizontal” and/or “vertical” entries 128 and 130, respectively, of the Info Canvas object 132 for that free grid.

B. Point-of-Origin of a Free Grid Can be Moved by the User at Any Time without Having to Enter Coordinate Information.

Free grids can be freely dragged to new locations that change their points-of-origin. As an example, the point-of-origin for a free grid is the upper left corner of the grid. In other words, free grids can be dragged to different locations in the same manner as other graphic objects in the Blackspace environment. A free grid can be moved by left mouse clicking anywhere on just the free grid (not on any object that is over the grid) and dragging the free grid in any direction while the left mouse is pressed.

Free grids, like overall grids, sit under other graphic objects. If a user left mouse clicks on any object sitting on a grid and then drag the cursor, the object will be moved (unless “move lock” feature is on for that object). However, if a user left mouse clicks on the free grid and drag the cursor, the free grid will be moved.

Graphic objects on a free grid can be moved along with the free grid if the objects are grouped with the free grid. This may be achieved by lassoing the objects to be grouped together using a lasso feature activated by a lasso switch (not shown). The objects can be lassoed by encircling the objects with the lasso or intersecting one or more of the objects with the lasso. The final step is to activate the entry “glue” of an Info Canvas object (not shown) for any lassoed object.

C. Free Grids Can be Resized at Any Time without Having to Enter Dimensional (Length and Width) Information.

Free grids can be resized as independent graphic objects. Similar to other graphic object in the Blackspace environment, free grids can be resized proportionally or non-proportionally. The following describes the steps to resize a free grid. Initially, a proportional or non-proportional resizing feature is activated. This can be achieved by activating a PN (proportional) switch or a NP (non-proportional) switch. Next, the mouse cursor is floated over the lower right corner of the free grid, which changes the cursor into a double arrow cursor. When the double arrow cursor is left mouse clicked and dragged, the size of the free grid will change accordingly. As the double arrow cursor is dragged, a dotted line (e.g., of red color) will appear at the bottom edge and/or right edge of the free grid to indicate that the size of the free grid is being changed. If the user releases the left mouse button before dragging a distance of at least the width or length of one free grid square, the free grid will snap back to it original size.

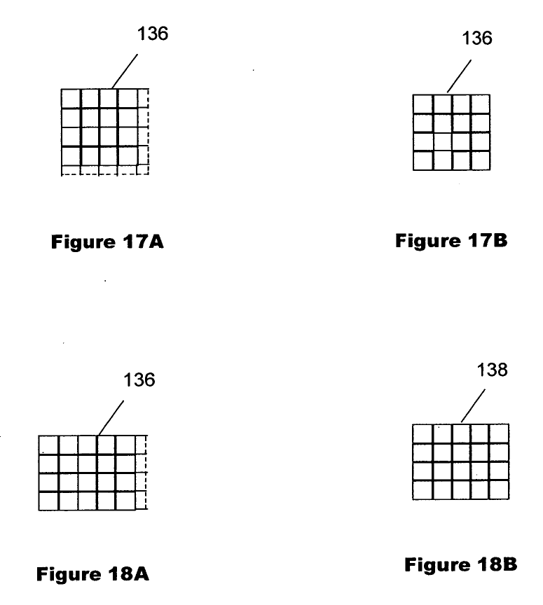

As an example, if there is a 4 by 4 free grid 136 and the user has dragged the double arrow cursor on the grid so that the fifth column and the fifth row are partially displayed, as illustrated in FIG. 17A, then the free grid will snap back to it's original size of 4 by 4 when the left mouse button is released at this cursor location, as illustrated in FIG. 17B. As another example, if the user has dragged the double arrow cursor on the same 4 by 4 free grid 136 so that the sixth column is now partially displayed, as illustrated in FIG. 18A, then the free grid will be changed to a 5 by 4 free grid 138 when the left mouse button is released at this cursor location, as illustrated in FIG. 18B.

The size of a free grid can also be changed by entering numeric values in the “width” and/or “height” entries 132 and 134, respectively of the Info Canvas object 132 for that free grids, as illustrated in FIG. 16.

D. One or More Free Grids Can Overlap Each Other.

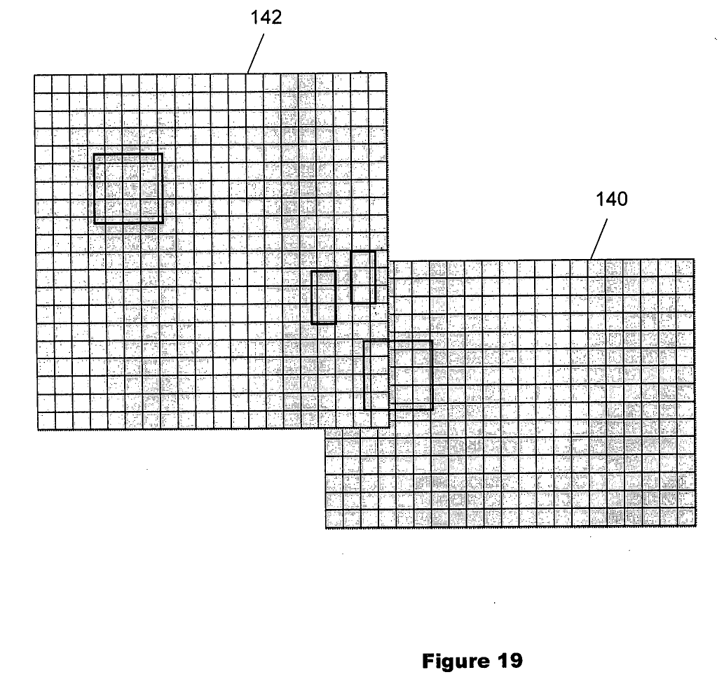

As illustrated in FIG. 19, when a first free grid 142 overlaps a second free grid 140 the portion of the first free grid that overlaps the second free grid automatically becomes opaque to the second free grid. Thus, in the overlapping region of the two free grids 140 and 142, only the grid lines of the top grid (i.e., the free grid 142) can be seen. Similarly, if a third free grid (not shown) overlaps portions of the first and second free grids, the only the grid lines of the third grid lines can be seen. For free grids, the last free grid that was selected by the user is on the upper most layer.

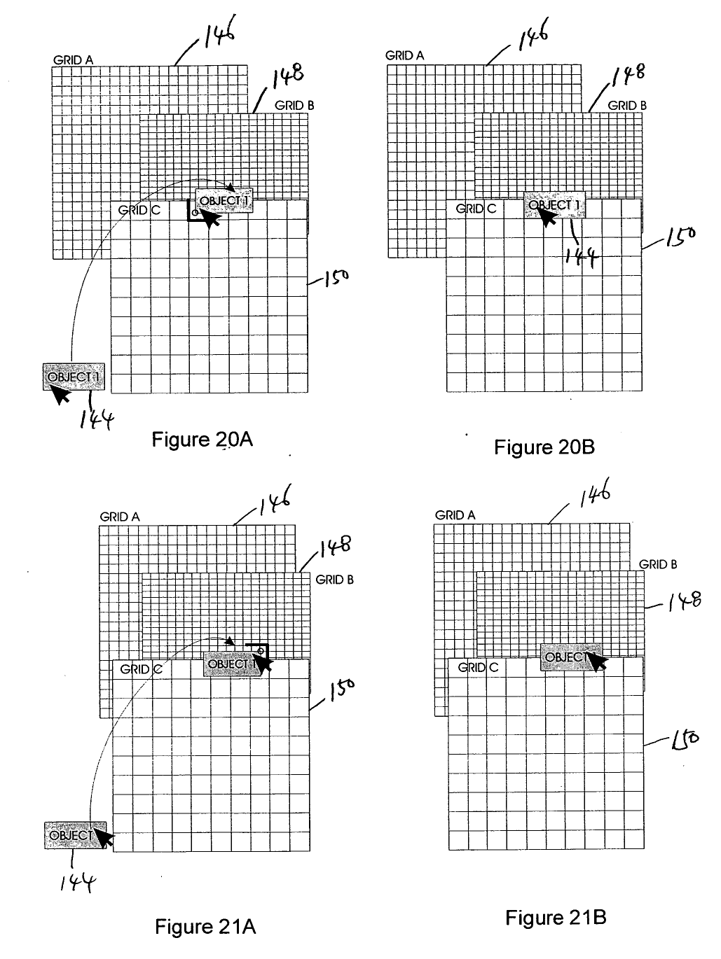

FIGS. 20A and 20B illustrate what happens when a graphic object 144 is move to a region where free grids 146, 148 and 150 overlap each other and released to be snapped. As shown in FIG. 20A, the free grid 146 (which can also be an overall grid) is overlapped by the free grid 148, which in turn is overlapped by the free grid 150. Also shown in the FIG. 20A, the graphic object is moved and dropped to straddle grids 148 and 150. FIG. 20B shows the position of the graphic object 144 after the object has been dropped. The object 144 has been aligned to the free grid 150, because the user has initially clicked on the standard bottom-edge hotspot and no other hotspot. Thus, the lower left corner align point of the object 144 has been selected, and the hints reflect this when the object moves over the free grid 150. Even though the grids 146, 148 and 150 (geometrically) enclose the selected align point of the object 144, the object is snapped to the grid 150, which has the highest Z level (layer) that encloses the align point of the object.

FIGS. 21A and 20B illustrate what happens when the graphic object 144 is moved to the same location on the grids 146, 148 and 150 but the selected align point is now the upper right corner align point of the object. Again, the object 144 is moved and dropped to straddle the grids 148 and 150. FIG. 21B shows the position of the graphic object 144 after the object has been dropped. The object 144 has been aligned to the free grid 148, because the user has initially clicked on the standard right-edge hotspot and no other hotspot. Thus, the upper left corner align point of the object 144 has been selected, and the hints reflect this when the object moves over the free grid 148. Even though the grids 146, 148 and 150 (geometrically) enclose the selected align point of the object 144, the object is snapped to the grid 150, which has the highest Z level (layer) that encloses the selected align point of the object.

E. Free Grids Can be Snapped to Other Free Grids or Overall Grids.

Since free grids are graphic objects, the free grids can be snapped to any other free grid or overall grids. In addition, since free grids can have different spacing settings and have different overall sizes, a complex composite of snapped free grids can be created (displayed).

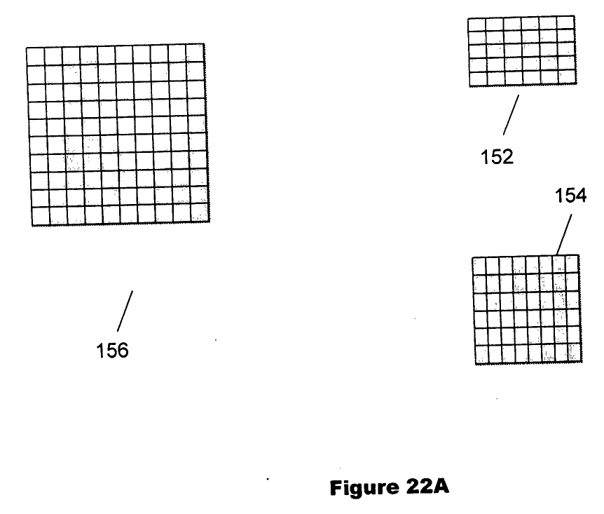

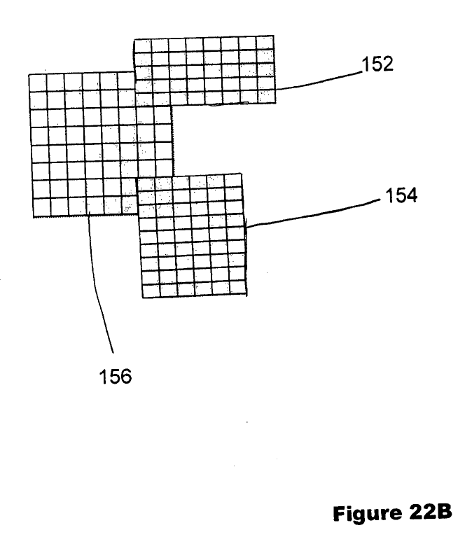

In FIG. 22A, three free grids 152, 154 and 156 having different spacing settings are shown. In FIG. 22B, the free grids 152 and 154 have been snapped to the free grid 156. Thus, the free grids 152, 154 and 156 have formed a customized composite grid. This composite grid can then be used to snap graphic objects to any grid line or grid vertex, even if the objects are not completely within the grid lines of the composite grid (this is true for any free grid). Alternatively, one or more of the free grids in this composite grid can be selectively activated with respect to the “snap to grid” option so that some of the graphic objects are snapped when released in certain regions of the composite grid, while some of the graphic objects are not snapped when released in certain other regions of the composite grid. As an example, if only the free grid 154 has been activated with respect to the “snap to grid” option, then graphic objects can only snap to the region of the composite grid defined by that free grid.

F. Where a Free Grid Overlaps Another Free Grid or an Overall Grid, Graphic Objects Can be Snapped to Partial Grid Squares.

When a free grid overlaps another free grid or an overall grid such that partial grid squares of the underlying grid are shown. If the “snap to grid” option for the underlying grid is active for horizontal and/or vertical grid lines, then graphic objects can be snapped to the exposed grid lines or vertexes of the underlying grid.

G. Free Grids Change their Colors When the “Snap to Grid” Option is Activated or Deactivated.

Similar to an overall grid, the color of the horizontal and/or vertical grid lines of a free grid changes as the “snap to grid” option is activated for horizontal and/or vertical grid lines to visually indicate which grid lines are active for the “snap to grid” option.

H. Free Grids Automatically Change their Background Colors to the Background Colors of VDACC Objects When Placed in the VDACC Objects.

If a free grid is in a VDACC object, the background color for the free grid will correspond to the background color for the VDACC object. Thus, if the background color for the VDACC object is changed, the background color for the free grid will also be changed accordingly.

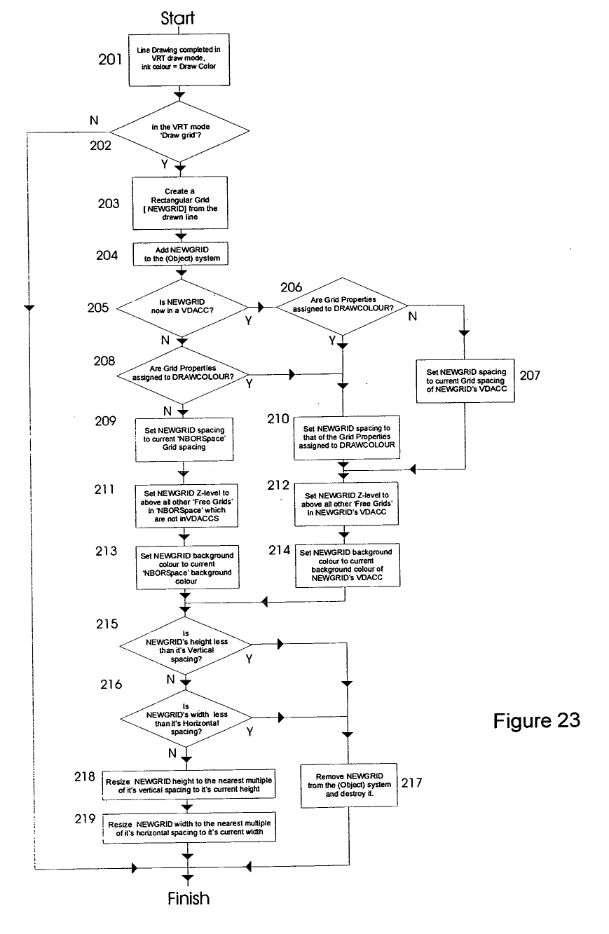

Turning now FIG. 23, a flowchart that shows the logical steps for a method of creating a new grid (“NEWGRID”) in accordance with an embodiment of the invention is shown. The color of the grid and the location of the grid determine the new grid's properties. The overall appearance and size of the grid are determined by the system if the grid is an overall grid. The overall appearance but not the size of the grid is determined by the system if the grid is a free grid. The flowchart of FIG. 23 is described below with reference to each processing block followed by a description.

Block 201—If the ‘Draw Grid’ mode is not active, no further action is taken, and no Grid is created. In the Info Canvas object for the VRT (visual recall tool) switch, there is a category entitled: “Create . . . ”. Under this category, there are various entries, which include: (a) Draw VDACC, and (b) Draw Grid.

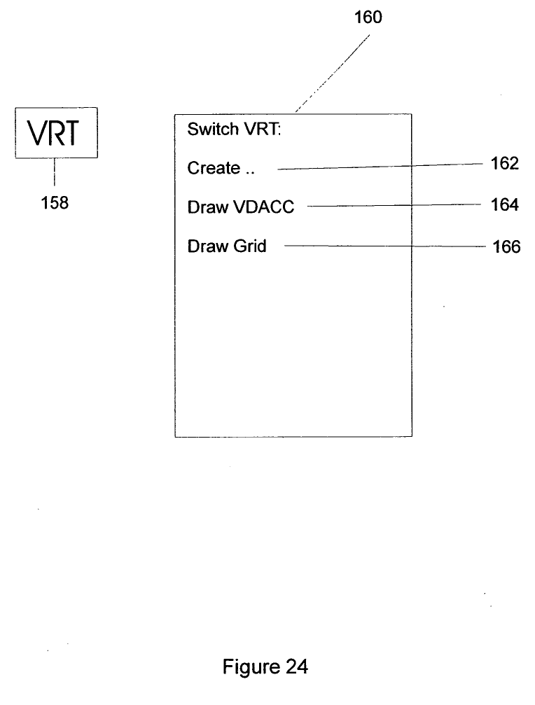

Referring to FIG. 24, a VRT switch 158 is right-clicked on (or its equivalent) and the Info Canvas object 160 for this switch appears. In this Info Canvas object 160 is the category “Create . . . ” 162, which include “Draw VDACC” entry 164 and “Draw Grid” entry 166. If the entry “Draw VDACC” 164 is selected (activated) by clicking on it, by verbal command or any equivalent of these, the VRT can be used to draw a VDACC object. For details of this operation refer to the pending U.S. patent application Ser. No. 10/053,075, entitled “Method for Controlling Electronic devices Using Digital Recall Tool, filed on Jan. 18, 2002.

If the entry “Draw Grid” 166 is activated under the “Create . . . ” category 162, then the VRT tool can be used to draw grids.

In either case, the operation is as follows. The VRT switch 158 is turned on and a diagonal line is drawn onscreen. The length and the angle of this drawn line determine the size of the VDACC object or grid that is drawn. If the “Draw Grid” entry 166 has been selected in the Info Canvas object 160 for the VRT switch 158, then drawing a diagonal onscreen will create a grid, whose height and width are determined by the length and angle of the drawn diagonal line. In one embodiment of this action, the drawn line turns into a grid when a mouse up-click is initiated.

NOTE: if the VRT tool is used to draw one or more grids, these grids are called “free grids.” Free grids exist as graphic objects and can be repositioned, resized, hidden, etc.

Block 202—A check is performed to see if the VRT is in the Draw Mode. The type of draw mode is determined by which one of the entries under the category “Create” in the Info Canvas object for the VRT switch, is turned on (activated).

Block 203—The drawn line is used to create a grid, as just described, such that the bounding rectangle of the grid has, as one of it's inter-vertex diagonals, the drawn line. After the mouse up-click is performed following the drawing of the diagonal line, the drawn line then disappears). This Grid is termed NEWGRID or Free Grid.

Block 204—NEWGRID is added to the screen management system.

Depending where it has been created, NEWGRID may be contained by an existing container Object such as a VDACC object. If so, NEWGRID will be added to the VDACC object and treated as it's ‘child’.

Blocks 206, 208 and 210—Properties may or may not be assigned to the color of DRAWCOLOR. If they are, those properties will be used as a user-preference. Grid properties which may be assigned to a DRAWCOLOR include it's size and spacing.

DRAWCOLOR as used in this document refers to the ability to assign any FreeGrid to a color in the VRT inkwell. For detailed information about the VRT, see pending U.S. patent application Ser. No. 10/053,075, entitled “Method for Controlling Electronic devices Using Digital Recall Tool, filed on Jan. 18, 2002.

To assign a free grid to a VRT color the following procedure can be implemented.
(a) Draw a FreeGrid in Primary Blackspace canvas or in a VDACC object.
(b) Draw an “assignment arrow” from the grid to intersect or point within a default gap to one of the color rectangles in the VRT inkwell and touch the arrowhead of this arrow when it turns white.

This will complete the process of assigning this grid to a specific VRT inkwell color. To recall the assigned grid to this VRT color the following process can be carried out.
(a) Select the color in the VRT inkwell that the Free Grid was assigned to.
(b) Turn on the VRT switch.
(c) Draw a diagonal line onscreen.

The length and angle of the drawn line will determine the width and height of the resulting Free Grid that appears onscreen after the mouse up-click following the completion of the drawing of this diagonal line.

The benefit of the assigning and subsequent drawing of such grids which are assigned to VRT inkwell colors is to be able to quickly recall many different types of grids, e.g., with different dimensions for their grid “squares” by simply selecting a color in the VRT inkwell and drawing one or more diagonal lines onscreen.

Block 207—Set NEWGRID's vertical and horizontal spacing to those of the containing VDACC (basic) grid current settings. If the properties of the grid are not assigned to a color, then the newly drawn grids will have the same spacing as the current user selecting settings.

NOTE: An example of these settings are the horizontal and vertical spacing of the grid squares. In other words, the width and height of the grid squares that make up the grid. These can be user selected in the Info Canvas object for the NEWGRID—the FreeGrid.

In this Info Canvas object these settings are labeled “Horizontal” and “Vertical”. Each of these entries is followed by a number which can be altered by a user to any desired number. The larger the number, the greater the horizontal and/or vertical length of the grid's “squares”. Another set of user parameters for a NEWGRID are “width” and “height”. Like the previous entries Horizontal and Vertical, the width and height entries are each followed by a number which is user changeable. These numbers control the overall height and width of the entire grid, as opposed to the length of width of each individual grid “square” that makes up the overall grid.

To change any of these parameters, the user would place a text cursor in the parameter and type a new number or alter part of an existing number.

Block 209—If the grid's properties are not assigned to a color, then the software sets NEWGRID's vertical and horizontal spacing to those of the last selected (the current) grid settings.

Blocks 211 and 212—Set the screen Z of NEWGRID to be above other Grids. This means that the layer level of the NEWGRID—the newly drawn Free Grid—will be set to a higher level than any existing Free Grid that is not in the VDACC object.

Blocks 213 and 214—The NEWGRID's background color is automatically changed to match the background color of the VDACC object. If the color of the VDACC object is controlled by a 24 bit color wheel, this means that the VDACC object can have approximately 16 million different colors. This means that a NEWGRID can have the same number or background colors.

In addition, the background color for a grid is OPAQUE. This ensures that each NEWGRID will appear ‘above’ the existing grids, as NEWGRID will obscure parts of other Grids where it overlaps them. So what happens is when a user drags a second free grid such that a portion of it overlaps a portion of and existing (a first) free grid, the portion of the second free grid that overlaps the first free grid will become opaque to the first free grid. This prevents the first free grids “grid lines” from showing through the overlapping portion of the second free grid. This ensures that the user will not see two sets of grids. Instead they will see one, the second grid that overlaps the first.

Blocks 215, 216 and 217—A grid cannot be smaller vertically or horizontally than its vertical or horizontal spacing respectively. If a NEWGRID is, it is deleted and no further action taken. For instance, if the horizontal spacing for an individual grid “square” is 25 pixels and the vertical spacing for this “square” is 25 pixels, any attempt to create a grid whose overall dimensions are less than 25 pixels will not cause a grid to be created onscreen.

Blocks 218 and 219—NEWGRID's bounding rectangle height and width are set to be the nearest multiple of it's vertical and horizontal spacing, respectively, as compared to it's height and width as first created. When a NEWGRID is created, this is accomplished by drawing a diagonal line. The user cannot know exactly how far to draw the line such that it's length will exactly equal the dimensions of a NEWGRID. Therefore the software makes the NEWGRIDs overall height and width equal the nearest next grid square dimension. For instance, if the diagonal drawn line equals a grid will 20.5 horizontal squares and 14.5 vertical grid squares, the software will automatically (upon the mouse upclick) create a NEWGRID that is comprised of 21 horizontal grid “squares” and 15 vertical “grid” squares.

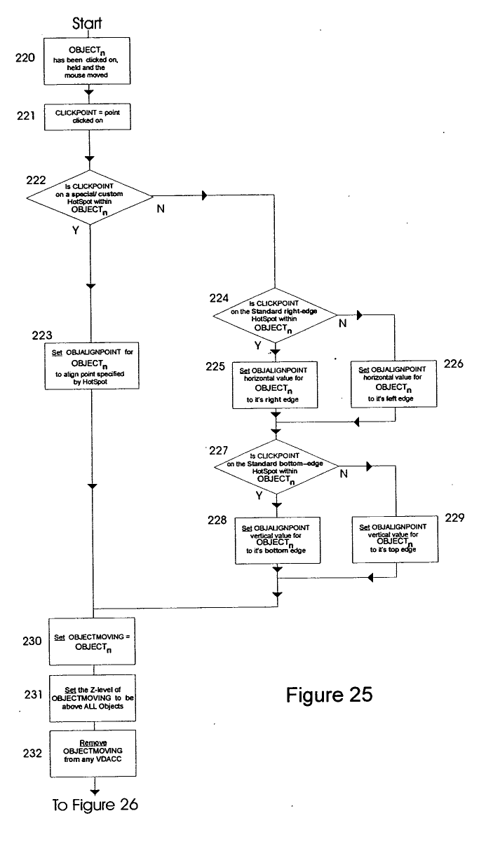

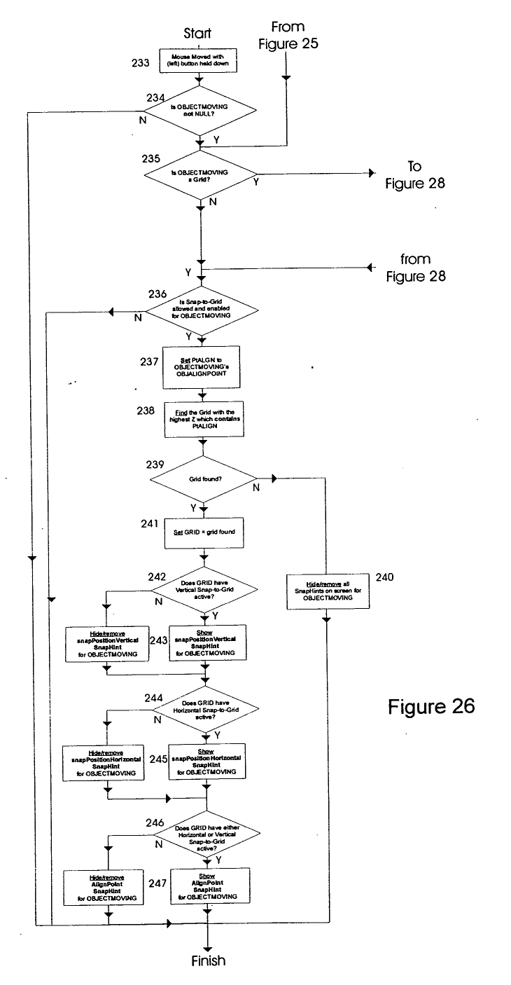

FIGS. 25, 26 and 27 show the logical steps for the method of using a Grid to align objects (including other Grids) by causing Objects to ‘Snap’ to positions when dragged/moved and dropped over a Grid. These ‘Snap’ to positions are determined by the Object's position relative to the Grid when the Object is dropped. Also included in these figures are the steps which provide instantaneous graphical user feedback during the move of the Object as to how and to which Grid the Object would snap should it be dropped at that instant.

The flowchart of FIG. 25 shows the snap-to-grid point calculation when object drag is begun.

Block 220—The user has moved an Object and “dropped” onto a grid it by releasing the mouse button (performing a mouse up-click). This Object is termed OBJECT n. An example of this would be left-clicking on a rectangle and dragging it onto a grid and then releasing the mouse—doing a mouse up-click.

Block 221—If ‘Snap-to-Grid’ is not allowed for OBJECT n, no further action is taken. If it is, then the point on the object where the mouse is clicked equals the click point. In other words, this is the point on the object where the mouse click has occurred.

Block 222—OBJECT n checks whether CLICKPOINT is on any of it's special Hotspots other than the standard edge Hotspots which all Objects have. Certain objects have special hotspots (special areas that become the snap point for that object). An example of such a hotspot could be one of the five tips of a five point star. A five point star would generally have four points that are represented by the four corners of the bounding rectangle that surrounds the five point star. With the use of additional hotspots (one for each of the tips of the star), a five point star could have nine separate hotspots or “snap points.” Any one of these snap points can be used to determine how the star will be snapped to a grid onto which it has been dragged. All the user needs to do is to click on the desired hotspot on and object and then drag that object.

Block 223—If CLICKPOINT is on any of it's special Hotspots, OBJECTALIGNPOINT for OBJECT n is set to the point associated with that Hotspot. For example, if a user left-clicks (or its equivalent) on the lower left corner of a rectangle object, then the lower left corner of that rectangle object will be snapped to the lower left corner of the nearest grid “square.” If the user left-clicks on the upper right corner of a rectangle object, this object will be snapped to the upper right corner of the nearest grid “square.” This of course, assumes that the rectangle has been dragged to overlap a grid and that the grid is active.

ALIGNPOINT is the point which is used both to generate the snap hints and to perform the final alignment of an object to a grid when the object is “dropped” onto the grid. In these flow charts the term SNAPPOINT and ALIGNPOINT refer to the same point. NOTE: Clickpoint may be equal to the snappoint or alignpoint but generally it will not be.

An example of when this is the case is when a user happens to click exactly on the alignpoint of an object In the case of this example the click would have to also be within a hotspot on this object.

OBJECTALIGNPOINT (OBJALIGNPOINT) is the point that is used by the software to generate the hints and in the process of the software accomplishing an alignment—the snapping of an object to a vertex of a grid “square.”

HOTSPOTS—The hotspots are used to give the user a margin of error to be able to click in an area on a given object, rather than on a specific point, in order to set the alignpoint for that object.

CLICKPOINT is the point where a user left-clicks with their mouse and starts to drag an object. This point is generally on an object that is being dragged such that it overlaps some portion of an existing Grid. This is important because when the object is dragged over a Grid, this clickpoint is used to determine the object's align point which in the flow charts is referred to a “OBJALIGNPOINT.”

The basic determination of OBJALIGNPOINT is described as blocks 223-229 in this flowchart of FIG. 25. The standard bottom edge and right edge hot spots are shown in FIG. 3.

SET—The term “set” means that from now on in a given flowchart a given term has a specific definition.

Blocks 224, 225 and 226—If a special Hotspot is not found containing the CLICKPOINT, and if the CLICKPOINT is on OBJECT n's Right Edge Hotspot, the horizontal coordinate of OBJALIGNPOINT is set to OBJECT n's right edge. Otherwise it is set to it's left edge.

Blocks 227, 228 and 229—If a special Hotspot is not found containing the CLICKPOINT, and if the CLICKPOINT is on OBJECT n's Bottom Edge Hotspot, the vertical coordinate of OBALIGNPOINT is set to OBJECT n's bottom edge. Otherwise it is set to it's top edge.

Block 230—OBJECT n is set as an Object which is currently being moved.

Block 231—This enables OBJECTMOVING to appear above all other Objects during the move.

Block 232—This frees OBJECTMOVING from any VDACC object and the VDACC object's influence on it's appearance, allowing it to appear ‘unclipped’ above VDACC objects during the move. For information regarding the clipping of objects into a VDACC object, see pending U.S. patent application Ser. No. xx/xxx,xxx, entitled “Intuitive Graphic User Interface with Universal tools”, filed on Sep. 26, 2003.

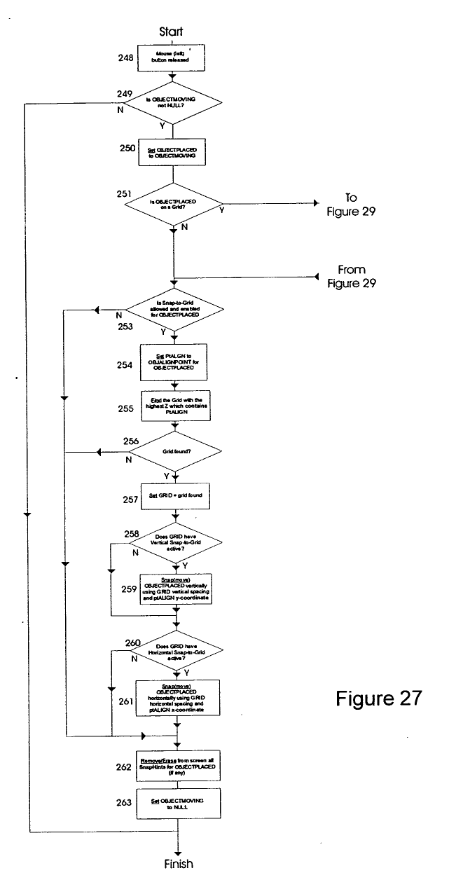

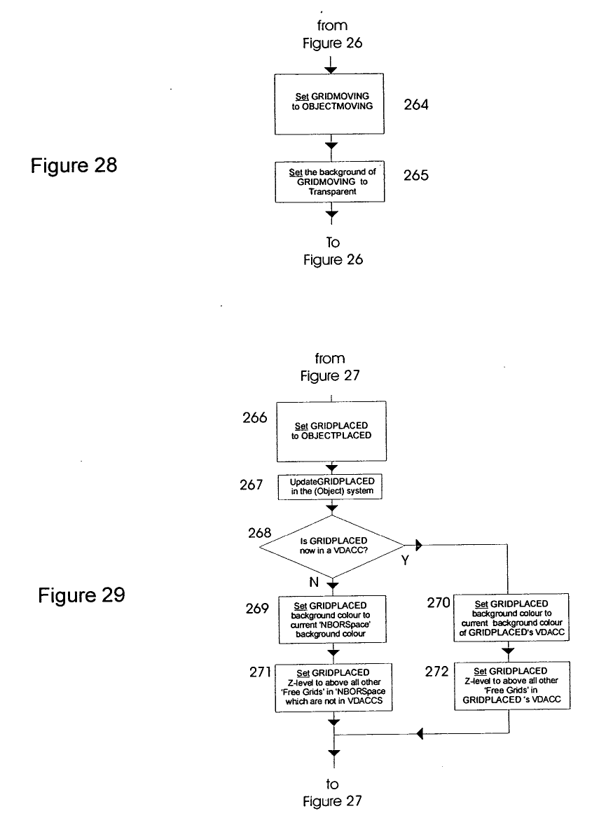

The flowchart of FIG. 26 illustrates an Object's interaction with Grids while being dragged.

Block 233—An object is being dragged by a mouse or its equivalent.

Block 234—This is a check to confirm that an Object is being moved—i.e. a dragging mouse event follows a mouse click on an Object. If no Object is moving, no further action is taken.

Block 235—If OBJECTMOVING is itself a Grid, further action is taken: see FIG. 28.

Block 236—If Snap-to-grid is disabled for OBJECTMOVING, take no further action

Block 237—PTALIGN is a point which is set to equal the OBJALIGNPOINT of that object.

“OBJECTMOVING” is defined as the object which a user is dragging.

“PtALIGN” is a point which is equal to OBJECTMoving's alignpoint.

“OBJECTMoving's align point” is a point computed by the software which is based upon the point on an object where a user left-clicks (or its equivalent) on an object. For instance, if a user left-clicks on the lower right corner of a rectangle object, this object's moving alignpoint is the lower right corner of that rectangle.

Block 238—PtALIGN may (because Grids can overlap) be contained by more than one Grid. The grid is found which contains PtALIGN and which currently appears ‘uppermost’ to the user by virtue of it's occlusion of ‘lower’ Grids where there is an overlap.

Blocks 239 and 240—If no containing grid is found, remove any Snap hints from the screen for OBJECTMOVING. An example of a snap hint is a small circle surrounding a vertex of an object that is the point for that object that will be snapped to a vertex of a grid “square.”

Blocks 242 and 243—If GRID has Horizontal Snap-to-Grid active, show the align position (Horizontal hint on the GRID on the screen), otherwise remove it (if currently displayed). This is a graphical indication of where OBJECTMOVING would snap (move to) horizontally if dropped at it's current position. An example of how this could look is shown in the example in diagram F. The hint is shown as a highlighted/thickened portion of the Grid line that OBJECTMOVING would align to if dropped.

Blocks 244 and 245—If GRID has Vertical Snap-to-Grid active show the align position Vertical hint on GRID on the screen, otherwise remove it (if currently displayed). This is a graphical indication of where OBJECTMOVING would snap (move to) vertically if dropped at it's current position. An example of how this could look is shown in the example in diagram F. The hint is shown as a highlighted/thickened portion of the Grid line OBJECTMOVING would align to if dropped.

Blocks 246 and 247—If GRID has Vertical or Horizontal Snap-to-Grid active, show the align point hint for OBJECTMOVING on the screen, otherwise remove it (if currently displayed) ). This is a graphical indication of the point on OBJECTMOVING which would be used to snap(align) it to GRID (horizontally or vertically or both) if dropped at it's current position. An example of how this could look is shown in the example in FIGS. 7A and 8A. The hint is shown as a small circle on the objects, most often at one of it's vertices.

The flowchart FIG. 27 illustrates an Object's interaction with Grids when dropped (placed) onto a grid after being dragged to overlap some portion of that grid.

Block 248—After dragging an object to overlap some portion of a grid a mouse up-click is performed.

Block 249—A check is made to confirm that an Object is being moved, i.e. a moving mouse event follows a click on an Object. If no Object is moving, no further action is taken.

Block 250—OBJECTPLACED is a reference to “OBJECTMOVING”. This means whenever the OBJECTPLACED is referred to in the flowchart, its current value will be OBJECTMOVING. OBJECTPLACED is an indication of the object that is going to be processed.

Block 251—If OBJECTMOVING is itself a Grid, further action is taken: see Diagram C2.

Block 253—If Snap-to-grid is disabled for OBJECTMOVING, take no further action.

Block 254—PtALIGN is a reference to alignpoint for the object placed. The object placed is the object being dragged to overlap a portion of a grid.

Block 255—PTALIGN may (because Grids can overlap) be contained by more than one Grid. The grid is found which contains PtALIGN and which currently appears ‘uppermost’ to the user by virtue of it's occlusion of ‘lower’ Grids where there is an overlap.

Block 256—If no containing grid is found, do not move OBJECTPLACED.

Block 257—Grid is a reference to the grid which contains PTALIGN. It's the grid with the highest layer or Zed level as we refer to it. What this says is that from now on this flow chart the term “GRID” equals the grid that has been found. NOTE: The term “set” means that from now on in a given flowchart a given term has a specific definition.

Blocks 258 and 259—If GRID has vertical Snap-to-Grid active, find the multiple of the GRID's vertical spacing numerically closest to the vertical coordinate of PtALIGN(call this value VALIGN), and move OBJECTPLACED so that it's OBJALIGNPOINT vertical coordinate in it's new position is equal to VALIGN . Otherwise skip.

Blocks 260 and 261—If GRID has Horizontal Snap-to-Grid active, find the multiple of GRID's horizontal spacing numerically closest to the horizontal coordinate of PtALIGN(call this value HALIGN), and move OBJECTPLACED so that it's OBJALIGNPOINT horizontal coordinate in it's new position is equal to HALIGN . Otherwise skip.

Block 262—Remove all snap hints for OBJECTPLACED (see above)

Block 263—Assert that the move operation has finished.

FIG. 28 shows the logical steps for the method of moving a Grid and changing it's appearance while doing so to provide enhanced screen clarity and user feedback.

Block 264—Set “GRIDMOVING′ to “OBJECTMOVING”, from this point on in the flow chart GRIDMOVING′ equals OBJECTMOVING.

Block 265—This sets GRIDMOVING to appear as a ‘Wireframe’ when it is dragged (moved) so that other screen Objects beneath it are visible between the Grid guidelines of GRIDMOVING.

When a grid is dragged (moved), its background changes from being opaque to being transparent while it is being dragged. This way other grids that it is dragged over can be fully viewed. NOTE: regarding other types of graphic objects, (non-grid objects), they can always been viewed through the grid, whether the grid is moving or non-moving. In other words, the grid appears transparent to these objects at all times. This special behavior is for the case where a grid is dragged over the top of one or more other grids.

FIG. 29 shows the logical steps for the method of dropping a Grid and changing it's appearance once dropped to provide enhanced screen clarity and user feedback.

Block 266—From this point on in the flowchart GRIDPLACED equals OBJECTPLACED.

Blocks 267 and 268—GRIDPLACED may have been dropped into a VDACC object.

Blocks 269 and 270—The opacity of GRIDPLACED is restored, and the background color set to match the color of it's new location, whether it be a VDACC object or Blackspace canvas.

Blocks 271 and 272—GRIDPLACED is set to appear as the topmost layer above all other grids in the VDACC object it is now in, or above all other grids in Blackspace canvas.

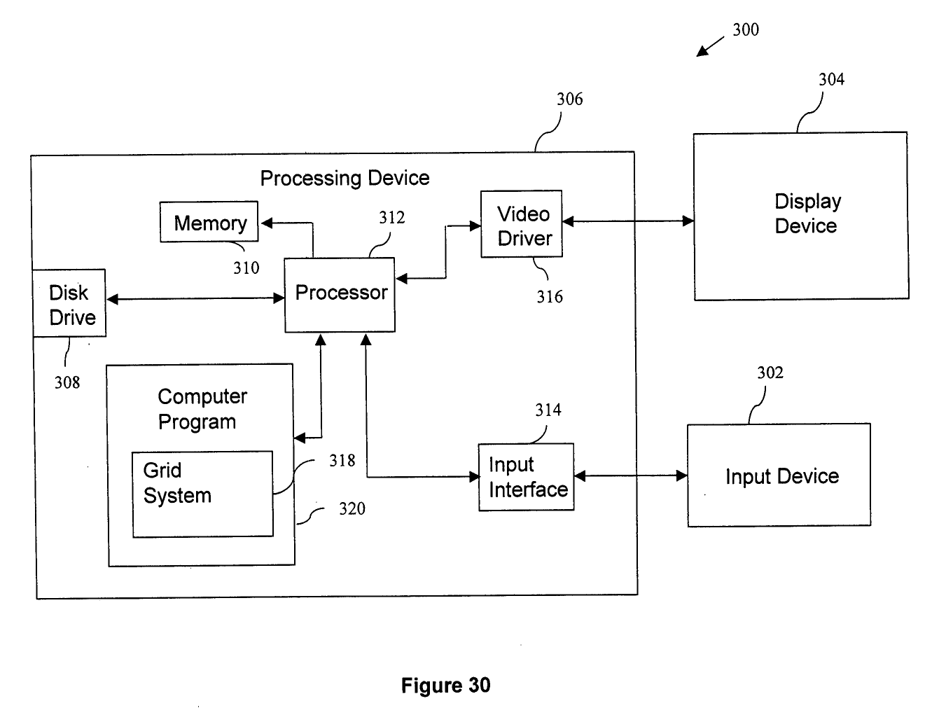

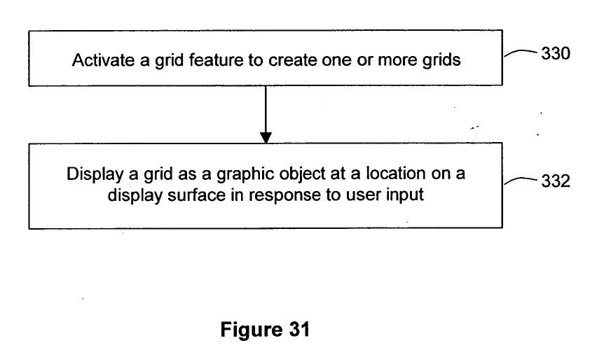

Turning now to FIG. 30, a computer system 300 in which the invention has been implemented is shown. The computer system 300 may be a personal computer, a personal digital assistant (PDA) or any computing system with a display device. In an embodiment, the invention may be embodied in a computer readable storage medium, such as a CD, that includes instructions, which can be executed by the computer system 300, to implement the invention in the system.

As illustrated in FIG. 30, the computer system 300 includes an input device 302, a display device 304 and a processing device 306. Although these devices are shown as separate devices, two or more of these devices may be integrated together. The input device 302 allows a user to input commands into the system 300 to, for example, draw or create a PAR. The input device 302 may include a computer keyboard and a mouse. However, the input device 302 may be any type of electronic input device, such as buttons, dials, levers and/or switches on the processing device 306. Alternative, the input device 302 may be part of the display device 304 as a touch-sensitive display that allows a user to input commands using a stylus. The display device 304 may be any type of a display device, such as those commonly found in personal computer systems, e.g., CRT monitors or LCD monitors.

The processing device 306 of the computer system 300 includes a disk drive 308, memory 310, a processor 312, an input interface 314 and a video driver 316. The processing device 306 further includes a grid system 318 that performs various functions associated with the invention. As shown in FIG. 30, the grid system 318 is implemented as part of a computer program 320, e.g., a Blackspace program that provides the Blackspace operating environment. In one embodiment, the grid system 318 is implemented as software. However, the grid system 318 may be implemented in any combination of hardware, firmware and/or software.

The disk drive 308, the memory 310, the processor 312, the input interface 314 and the video driver 316 are components that are commonly found in personal computers. The disk drive 308 provides a means to input data and to install programs into the system 300 from an external computer readable storage medium. As an example, the disk drive 308 may a CD drive to read data contained therein. The memory 72 is a storage medium to store various data utilized by the computer system 300. The memory 310 may be a hard disk drive, read-only memory (ROM) or other forms of memory. The processor 312 may be any type of digital signal processor that can run the computer program 320, including the grid system 318. The input interface 314 provides an interface between the processing device 306 and the input device 302. The video driver 316 drives the display device 304. In order to simplify the figure, additional components that are commonly found in a processing device of a personal computer system are not shown or described.

A method for creating and using grids in accordance with an embodiment of the invention is described with reference to a flow diagram of FIG. 31. At block 330, a grid feature is activated to create one or more grids. Next, at block 332, a grid is displayed as a graphic object at a location on a display surface in response to user input. The grid includes parallel lines along a first direction and at least one line along a second direction to intersect one of the parallel lines. The size and location of the grid are defined by the user input.

Although specific embodiments of the invention have been described and illustrated, the invention is not to be limited to the specific forms or arrangements of parts so described and illustrated. The scope of the invention is to be defined by the claims appended hereto and their equivalents.

1. A method for creating and using a grid, said method comprising:
activating a grid feature to create said grid; and
displaying said grid as a graphic object at a location on a display surface in response to user input, said grid including a first plurality of parallel lines along a first direction and at least one line along a second direction to intersect one of said parallel lines, said grid being of a size defined by said user input, said location of said grid being further defined by said user input.

2. The method of claim 1 further comprising displaying a second grid as a second graphic object at a second location of said display surface in response to another user input.

3. A graphical user interface for creating and using a grid, said graphic user interface comprising:
a surface on which graphic objects can be displayed; and
a grid of a user-defined size displayed on said surface at a user-defined location, said grid being a graphic object that can be moved on said surface in response to user input.

4. The graphic user interface of claim 3 further comprising a second grid of a user-defined size displayed on said surface at a user-defined location, said second grid also being a graphic object that can be moved on said surface in response to user input.

5. A storage medium readable by a computer, tangibly embodying a program of instructions executable by said computer to perform method steps for creating and using a grid, said method steps comprising:
activating a grid feature to create said grid; and
displaying said grid as a graphic object at a location on a display surface in response to user input, said grid including a first plurality of parallel lines along a first direction and at least once line along a second direction to intersect one of said parallel lines, said grid being of a size defined by said user input, said location of said grid being further defined by said user input.

6. The storage medium of claim 5 further comprising displaying a second grid as a second graphic object at a second location of said display surface in response to another user input.
